(19) United States
(12) Patent Application Publication
(10) Pub. No.: US 2010/0151727 A1
(43) Pub. Date: Jun. 17, 2010

(54) ELECTRICAL CONNECTOR INCORPORATED WITH NUT HAVING BARBS

(75) Inventors: YU LUO, Shenzhen (CN); BO YAN, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/637,773

(22) Filed: Dec. 15, 2009

(30) Foreign Application Priority Data
Dec. 15, 2008 (CN) 200810306240.9

(51) Int. Cl. H01R 13/73

(52) U.S. Cl. 439/544

(57) ABSTRACT

An electrical connector comprises an insulating housing having a main body and a mating portion extending forwardly from a front surface of the main body. The main body defines a mounting surface perpendicular to the front surface and a top surface opposite to the mounting surface. The main body defines a pair of receiving cavities located at two ends thereof, a pair of nuts are received in the receiving cavities respectively. Each nut comprises a board-shaped base portion, a threaded portion stamped from the base portion and a threaded hole therethrough. A plurality of terminals are assembled to the insulating housing. A pair of bolt-inserting apertures penetrate from the top surface to the mounting surface through the threaded holes of nuts respectively. The base portion defines a retention portion interfering with internal walls of the receiving cavity.

### BACKGROUND OF THE INVENTION

1. Field of the Invention

The present invention relates to an electrical connector, and more particularly to an electrical connector incorporated with a retention system for retaining the electrical connector on a printed circuit board.

2. Description of Related Art

It is well known to provide an electrical connector mountable to a printed circuit board (hereinafter PCB), which has terminals electrically engaging with respective electrical circuit traces on the PCB. A problem is existed in said connector that the electrical connections between the terminals and the circuit traces of the PCB are often subjected to external force, which sometimes will cause the connections break. To resolve the problem, board locking mechanisms have been introduced.

U.S. Pat. No. 5,249,983 issued to Hirai on Oct. 5, 1993 discloses a connector having bolt/nut devices for retaining the connector to a PCB, thereby securing the electrical connection between terminals of the connector and circuit traces of the PCB. Referring to FIGS. 1 to 3B of the patent Hirai '983, the housing 1 of the connector defines a pair of parallel compartments 6 in a top wall thereof and a pair of vertical bolt-inserting apertures 11 extending through a bottom wall thereof from the recesses 6. A nut 13 is interferentially fitted in each recess 6. Once the connector is placed onto a PCB 17 with through holes 18 in align with the apertures 11, a bolt 20 is inserted in each through hole 18 and through respective aperture 11 along a bottom-to-top direction, and then screwed down into the nut 13. It is noted that each compartments 6 is further formed with extended projections 10 on an internal surface thereof to interfere with the nut for retaining the nut therein.

However, when the nuts 13 are assembled into the recesses 6, additional tools have to be used. Furthermore, in order to secure the nuts 13 in the compartments 6, a small tolerance is required between the nuts and the projections 10 of the compartments 6. As a result, requirements for accuracy of the projections are tremendously high which inevitably increases the whole cost of the connector. For example, if the size of each projection of the recess is a little larger than a standard size, the nut could not be fitted in the recess, and if the size of each projection is a little smaller than the standard size, the nut could not be secured in the recess and would be pushed out as the bolt 20 intents to engage with the nut.

Hence, an improved electrical connector is required to overcome the disadvantages of the prior art.

### SUMMARY OF THE INVENTION

Accordingly, an object of the present invention is to provide an electrical connector having an improved retention system for retaining the electrical connector on a printed circuit board reliably.

In order to achieve the above-mentioned object, an electrical connector comprises an insulating housing having a main body and a mating portion extending forwardly from a front surface of the main body. The main body defines a mounting surface perpendicular to the front surface and a top surface opposite to the mounting surface. The main body defines a pair of receiving cavities located at two ends thereof, a pair of nuts are received in the receiving cavities respectively. Each nut comprises a board-shaped base portion, a threaded portion stamped from the base portion and a threaded hole therethrough. A plurality of terminals are assembled to the insulating housing. A pair of bolt-inserting apertures penetrate from the top surface to the mounting surface through the threaded holes of nuts respectively. The base portion defines a retention portion interfering with internal walls of the receiving cavity.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an exploded, perspective view of an electrical connector according to an embodiment of the present invention;

FIG. 2 is a perspective view of a nut of the electrical connector of FIG. 1;

FIG. 3 is an perspective view of the electrical connector of FIG. 1;

FIG. 4 is an exploded, perspective view of an electrical connector of a second embodiment of the inventor; and

FIG. 5 is a perspective view of a bolt of the electrical connector of FIG. 4.

### DETAILED DESCRIPTION OF THE INVENTION

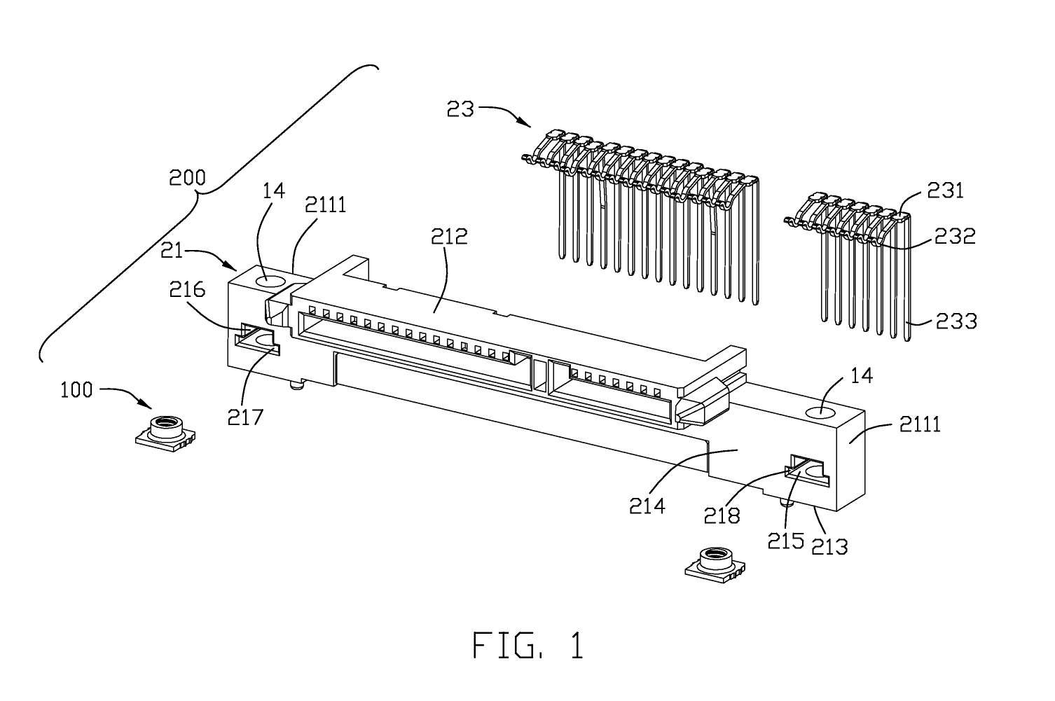

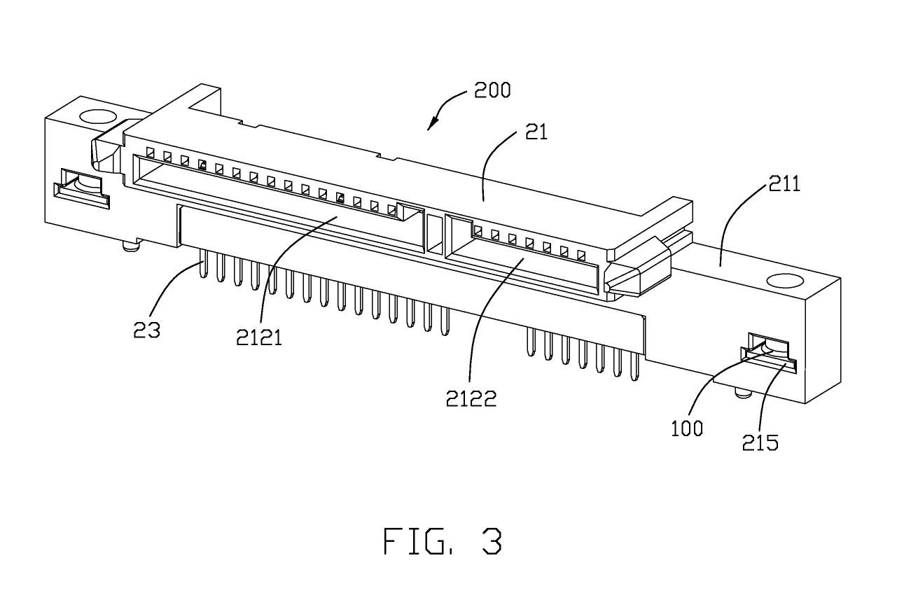

Referring to FIGS. 1 to 3, an electrical connector 200 adapted for mounting on a printed circuit board according to an embodiment of the present invention is shown to include an insulating housing 21 and a plurality of terminals 23 assembled to the insulating housing 21.

The insulating housing 21 comprises a main body 211 and a mating portion 212 extending forwardly from a front surface 214 of the main body 211, the main body 211 defining a mounting surface 213 perpendicular to the front surface 214 and a top surface opposite to the mounting surface 213. The mating portion 212 defines a first receiving port 2121 and a second receiving port 2122 adjoining to the first receiving port 2121, which two respectively define a plurality of receiving passageways 2123 extending through the mating portion 212 in a mating direction, respectively.

Each terminal 23 comprises a base section 231 received in said passageway 2123, a contact section 232 exposed in the receiving port and a tail portion 233 extending beyond the mounting surface 213 of the main body 211.

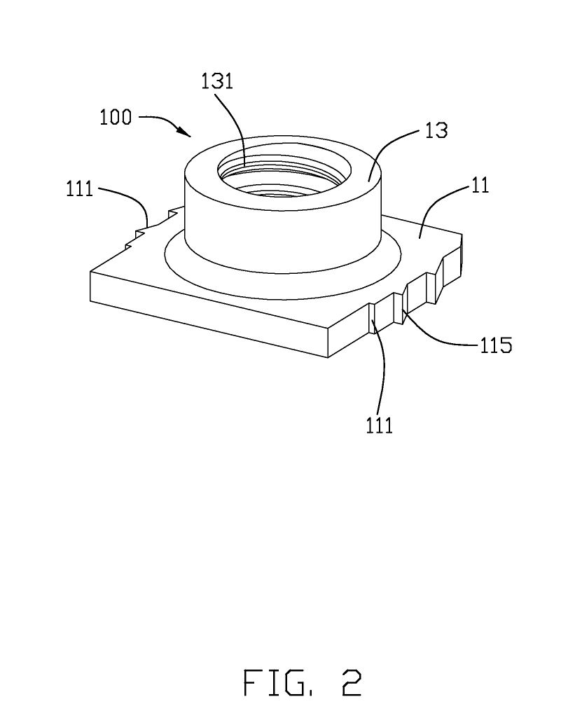

Referring particularly to FIG. 2, the main body 211 comprises two mounting portions 2111 at two ends thereof. Each mounting portion 2111 defines a receiving cavity 215, a pair of nuts 100 are securely positioned in the receiving cavities 215 respectively. Each nut 100 comprises a base portion 11, a threaded portion 13 stamped from the base portion 11 and a threaded hole 131 therethrough, a pair of bolt-inserting apertures 14 penetrate from the top surface to the mounting surface 213 of the housing and through the threaded holes 131 of nuts respectively. The base portion 11 defines a retention portion which interferes with internal walls 218 of the receiving cavity 215.

The base portion 11 comprises two opposite sidewalls 111 which are parallel to the mating direction of the complementary connector. The retention portion comprises a plurality of barbs 115 formed on the two sidewalls 111. Each receiving cavity 215 comprises a first cavity 217 for receiving the main portion 11 and a second cavity 216 for receiving the threaded hole 131.

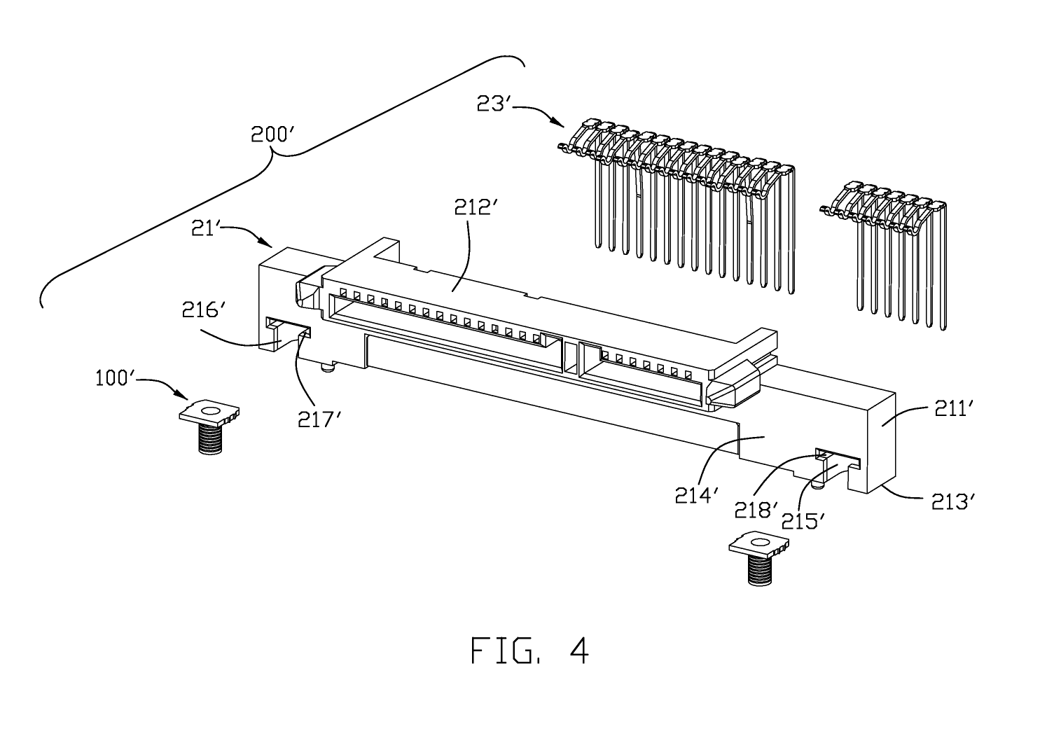

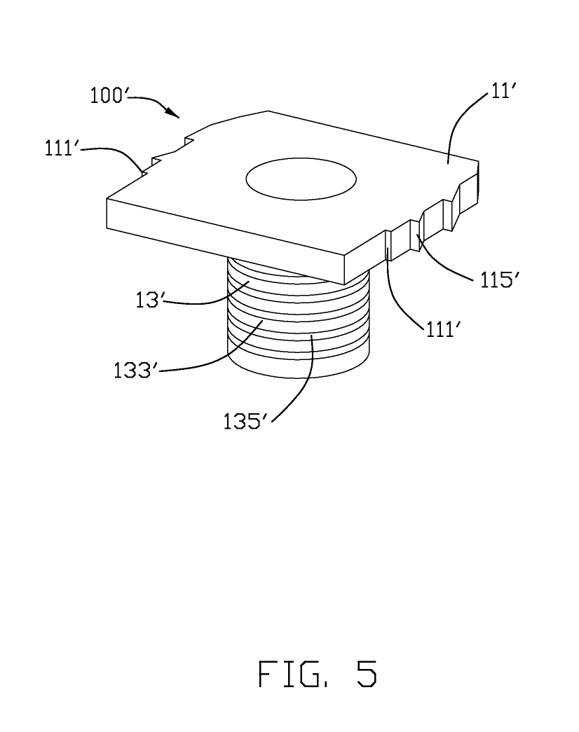

A second embodiment of an electrical connector is provided in FIGS. 4 and 5. An electrical connector 200′ includes an insulating housing 21′ and a plurality of terminals 23′ assembled to the insulating housing 21′. The insulating housing 21′ having a main body 211′ and a mating portion 212′ extending forwardly from a front surface 214′ of the main body 211′, the main body 211′ defining a mounting surface 213′ perpendicular to the front surface 214′.

The main body 211′ defines a pair of receiving cavities 215′ penetrating through the mounting surface 213′ and located at two sides thereof. A pair of bolts 100′ are secured in the receiving cavities 215′ respectively. Each bolt 100′ comprises a base portion 11′ and a threaded portion 13′ stamped from the base portion 11′. The threaded portion 13′ extends beyond the mounting surface 213′ for fastening to a printed circuit board. The base portion 11′ defines a retention portion which interferes with internal walls 218′ of the receiving cavity 215′. The threaded portion 13′ is a cylindrical body with threads 135′ formed in its outer surface 133′.

The base portion 11′ comprises two opposite sidewalls 111′ which are parallel to the mating direction of the complementary connector. The retention portion comprises a plurality of barbs 115′ formed on the two sidewalls 111′. Each receiving cavity 215′ comprises a first cavity 217′ for receiving the base portion 11′ and a second cavity 216′ for receiving the threaded portion 13′.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector comprising:
an insulating housing having a main body and a mating portion extending forwardly from a front surface of the main body, the main body defining a mounting surface perpendicular to the front surface and a top surface opposite to the mounting surface, the main body defining a pair of receiving cavities located at two ends thereof, a pair of nuts received in the receiving cavities respectively, each nut comprising a board-shaped base portion, a threaded portion stamped from the base portion and a threaded hole therethrough;
a plurality of terminals assembled to the insulating housing; and
a pair of bolt-inserting apertures penetrating from the top surface to the mounting surface through the threaded holes of nuts respectively;
wherein the base portion defines a retention portion interfering with internal walls of the receiving cavity.

2. The electrical connector as described in claim 1, wherein the base portion comprises two opposite sidewalls, which are parallel to a mating direction of the electrical connector, the retention portion comprises a plurality of barbs formed on the two sidewalls.

3. The electrical connector as described in claim 2, wherein each receiving cavity comprises a first cavity for receiving the main portion and a second cavity for receiving the threaded hole.

4. The electrical connector as described in claim 3, wherein the mating portion defines a first receiving port and a second receiving port adjoining to the first receiving port, the first receiving port and the second receiving port respectively defines a plurality of receiving passageways extending through the mating portion in the mating direction.

5. The electrical connector as described in claim 4, wherein each terminal comprises a base section received in said passageway, a contact section exposing in the receiving port and a tail portion extending beyond the mounting surface of the main body.

6. An electrical connector comprising:
an insulating housing comprising a mating portion extending forwardly therefrom and a pair of receiving cavities adjacent to two ends of the housing, the receiving cavity running through a front face of housing and comprising a upper portion and a lower portion;
a plurality of terminals assembled in the insulating housing; and
a pair of bolts secured in the receiving cavities respectively from the front face, each bolt comprising a base portion with a plurality of barbs interfering with the upper portion and a threaded portion stamped from the base portion in the upper portion, the threaded portion extending beyond the mounting surface for fastening a printed circuit board.

7. The electrical connector as described in claim 6, wherein the threaded portion is a cylindrical body with screw threads formed in its outer surface.

8. The electrical connector as described in claim 7, wherein the base portion comprises two opposite sidewalls, which are parallel to the mating direction of the complementary connector, the plurality of barbs are formed on the two sidewalls.

9. The electrical connector as described in claim 8, wherein the mating portion defines a first receiving port and a second receiving port adjoining to the first receiving port, the first receiving port and the second receiving port respectively defines a plurality of receiving passageways extending through the mating portion in the mating direction.

10. An electrical connector comprising:
an insulative housing defining a mating port for receiving a complementary connector;
a plurality of contacts disposed in the housing with contacting sections exposed around the mating port;
a unitary one piece fastener assembled to the housing and defining a base portion extending in a plane perpendicular to an axial direction of a threaded portion extending from the base portion;
a fastener receiving cavity formed in the housing beside said mating port, said housing defining a first opening, which extends in a first direction, to communicate said receiving cavity with an exterior for loading said fastener into said fastener receiving cavity along said first direction, and a second opening, which extends in a second direction perpendicular to said first direction, for allowing a threaded bolt to extend therethrough along said axial direction; wherein
said base portion, which is dimensioned larger than a cross-section of said threaded portion, is equipped with retention devices thereon for retaining the fastener in the fastener receiving cavity securely.

11. The electrical connector as claimed in claim 10, wherein said threaded portion is tubular with internal threads thereof for engagement with said threaded bolt.

12. The electrical connector as claimed in claim 10, wherein said threaded portion is said threaded bolt with external threads thereof.

13. The electrical connector as claimed in claim 10, wherein said retention devices are barbs formed on lateral sides of said base portion.

14. The electrical connector as claimed in claim 10, wherein said mating port communicates with the complementary connector in said first direction.

15. The electrical connector as claimed in claim 10, wherein said first opening defines a hat like configuration in an elevational view.

16. The electrical connector as claimed in claim 15, wherein said threaded portion is dimensioned larger than said base portion in said axial direction.

17. The electrical connector as claimed in claim 10, wherein said first opening extends through a bottom face of the housing when said threaded portion is said threaded bolt with external threads thereof.

18. The electrical connector as claimed in claim 10, wherein said mating port and said first opening is located on a same face of the housing.

19. The electrical connector as claimed in claim 10, wherein said second opening faces said exterior upwardly when said threaded portion is tubular with internal threads thereof for engagement with said threaded bolt, while said second opening faces said exterior downward when said threaded portion is said threaded bolt with external threads thereof.
